(19) United States
(12) Patent Application Publication
(10) Pub. No.: US 2012/0050213 A1
(43) Pub. Date: Mar. 1, 2012

(54) REDUCED NOISE CAPACITIVE SCAN

(76) Inventor: Louis W. BOKMA, San Jose, CA (US)

(21) Appl. No.: 12/950,693

(22) Filed: Nov. 19, 2010

Related U.S. Application Data
(60) Provisional application No. 61/377,817, filed on Aug. 27, 2010.

(51) Int. Cl. G06F 3/045

(52) U.S. Cl. 345/174; 178/18.06

(57) ABSTRACT

A touch sensing system is disclosed that can include a firmware module stored in memory and executed at run time to store values into a hardware register for configuring various parameters of capacitive sensing system to reduce quantization and scan noise, reduce interference with neighboring electronics, and avoid noise aggressors. In addition, a serial peripheral interface (SPI) can be employed to allow a host controller to access information about the performance of touch controller and send communications back to touch controller to make run-time changes to the parameters of touch controller.

### CROSS-REFERENCE TO RELATED APPLICATIONS

This application claims the benefit of U.S. Provisional Application No. 61/377,817 filed Aug. 27, 2010, the contents of which are incorporated by reference herein in their entirety for all purposes.

### FIELD

This relates generally to a touch sensing system, and more particularly, to configuring and controlling the touch sensing system to reduce measurement errors and avoid noise.

### BACKGROUND

In recent years, touch sensor panels, touch screens, and the like have become available as input devices. Touch screens, in particular, are becoming increasingly popular because of their ease and versatility of operation as well as their declining price. Touch screens can include a touch sensor panel, which can be a clear panel with a touch-sensitive surface, and a display device, such as an LCD panel, that can be positioned partially or fully behind the touch sensor panel or integrated with the touch sensor panel so that the touch-sensitive surface can cover at least a portion of the viewable area of the display device. Touch screens can allow a user to perform various functions by touching (or nearly touching) the touch sensor panel using one or more fingers, styli or other objects at a location often dictated by a user interface (UI) being displayed by the display device. In general, touch screens can recognize a touch event and the position of the touch event on the touch sensor panel, and a computing system can then interpret the touch event in accordance with the display appearing at the time of the touch event, and thereafter can perform one or more actions based on the touch event.

The touch sensor panel can be constructed as an array of touch electrodes and/or pixels, each electrode or pixel capable of sensing a touch event (one or more touches or near-touches) occurring at the location of the electrode or pixel. To determine the locations of one or more touch events, a scan of the touch sensor panel can be performed during which time one or more pixels or electrodes can be evaluated in sequence for touch event activity until an “image” of touch is obtained for the entire panel. However, some capacitive scanning methodologies can produce inconsistent or “noisy” results because of a lack of synchronization, a lack of precision in establishing a known circuit state prior to performing certain scanning tasks, or the presence of noise aggressors. In addition, the noise generated by some capacitive scanning methodologies can interfere with the performance of nearby electronics. These problems are exacerbated by a lack of control over parameters of the capacitive scanning system.

### SUMMARY

This relates to controlling and configuring certain parameters in a capacitive scanning system to enable synchronization and initialization of measurement circuitry to reduce measurement noise, and to performing certain scanning functions at various frequencies to reduce interference with neighboring electronics and avoid noise aggressors.

In some embodiments, firmware can be utilized to configure various parameters of a touch controller to reduce measurement noise, reduce interference with neighboring electronics, and avoid noise aggressors. In addition, information about the performance of the touch controller can be accessed in real time, and communications can be sent to the touch controller to make run-time changes to the parameters of touch controller circuits and improve overall performance.

In some embodiments, interrupt-driven synchronization of a gate signal for enabling a capacitance measurement phase in a switched capacitor sensing system can be employed to reduce measurement noise. In other embodiments, pre-charging of an integration capacitance C_{INT} prior to the start of an electrode or pixel scan can result in more consistent measurements and less scan noise. In still other embodiments, the multiple charge/discharge cycles within each gate interval defined by the gate signal can be performed at different frequencies to avoid generating noise at a particular frequency. In still other embodiments, the nominal frequency (f_{NOM}) of the charge/discharge cycles can be adjusted to avoid noise aggressors.

### BRIEF DESCRIPTION OF THE DRAWINGS

FIG. 1 illustrates an exemplary touch sensing system according to some embodiments of the disclosure.

FIG. 2 illustrates an exemplary touch sensor panel according to some embodiments of the disclosure.

FIG. 3 provides a more detailed view of an exemplary touch sensing system including more detailed block diagrams of a touch controller and a capacitive scanning system according to some embodiments of the disclosure.

FIG. 4 illustrates an exemplary timing diagram of certain operations of FIG. 3 according to some embodiments of the disclosure.

FIG. 5 illustrates a timing diagram showing an exemplary synchronization of the start of the capacitance measurement phase and the gate signal according to some embodiments of the disclosure.

FIG. 6 illustrates a timing diagram showing an exemplary use of different charge/discharge cycle frequencies to avoid noise generation according to some embodiments of the disclosure.

FIG. 7a illustrates an exemplary digital media player that can include a touch sensing system according to some embodiments of the disclosure.

FIG. 7b illustrates an exemplary mobile telephone that can include a touch sensing system according to some embodiments of the disclosure.

FIG. 7c illustrates an exemplary personal computer that can include a touch sensing system according to some embodiments of the disclosure.

### DETAILED DESCRIPTION

In the following description, reference is made to the accompanying drawings which form a part hereof, and in which it is shown by way of illustration specific embodiments which can be practiced. It is to be understood that other embodiments can be used and structural changes can be made without departing from the scope of the embodiments of this disclosure.

This relates to controlling certain parameters in a capacitive scanning system to enable synchronization and initialization of measurement circuitry to reduce measurement noise, and to perform certain scanning functions at various frequencies to reduce interference with neighboring electronics and avoid noise aggressors.

Although embodiments of the disclosure may be described herein with respect to self-capacitance touch sensor panels (for which a touch on an electrode or pixel typically can cause an increase in capacitance of the sensing electrode to the panel or system ground), embodiments of the disclosure are not so limited, but can include mutual capacitance touch sensor panels (for which a touch on the panel can cause a decrease in capacitance between two neighboring electrodes). Those skilled in the art will understand that the circuitry described and illustrated herein can be easily modified to detect faster charging times and more counts in a given evaluation period as indicators of a touch event. In addition, although embodiments of the disclosure may be described herein with respect to touch sensor panels and touchscreen devices, the capacitive sensing embodiments described herein are not so limited, and can be used for many types of capacitive sensing measurements.

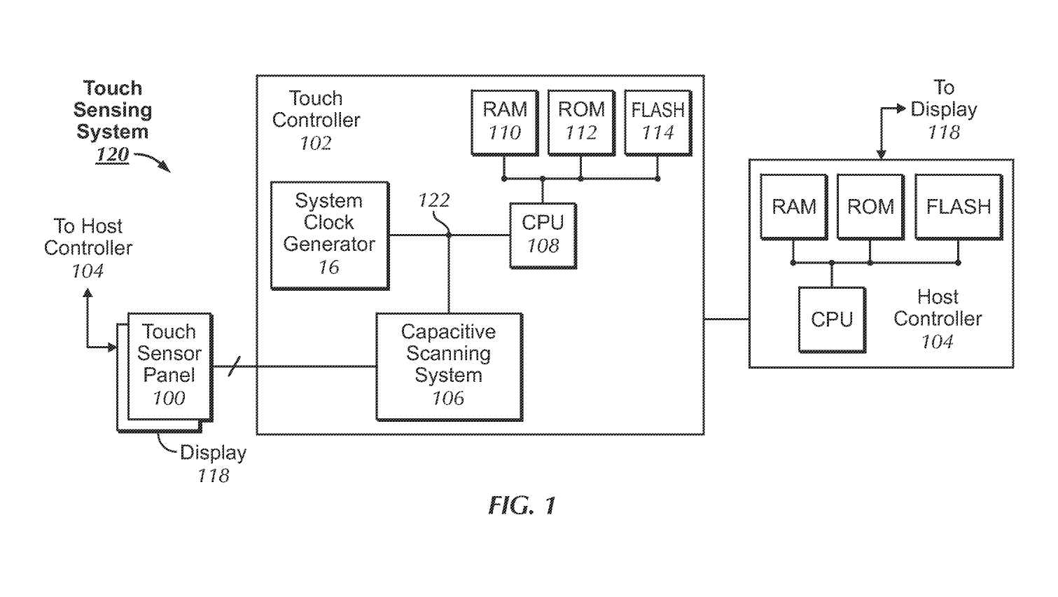

FIG. 1 illustrates an exemplary touch sensing system 120 according to some embodiments of the disclosure. In the example of FIG. 1, touch controller 102 can be coupled to touch sensor panel 100 and host controller 104. In touchscreen embodiments, host controller 104 can be coupled to display 118, which can be positioned partially or fully behind touch sensor panel 100 or integrated with the touch sensor panel so that the touch sensor panel can cover at least a portion of the viewable area of the display. In some embodiments, touch controller 102 can include capacitive scanning system 106 for measuring the capacitance at the electrodes or pixels of touch sensor panel 100. CPU 108, along with RAM 110, ROM 112 and flash 114, can configure and control capacitive scanning system 106 under control of system clock 122 from system clock generator 116 to obtain and forward touch data to host controller 104. It should be understood that the basic architecture of touch controller 102 illustrated in FIG. 1 is only exemplary, and that other touch controller designs can be employed according to embodiments of the disclosure. For example, in mutual capacitance embodiments, the touch controller can include driving circuitry and charge pump circuitry for generating stimulation signals at a proper amplitude, frequency and phase.

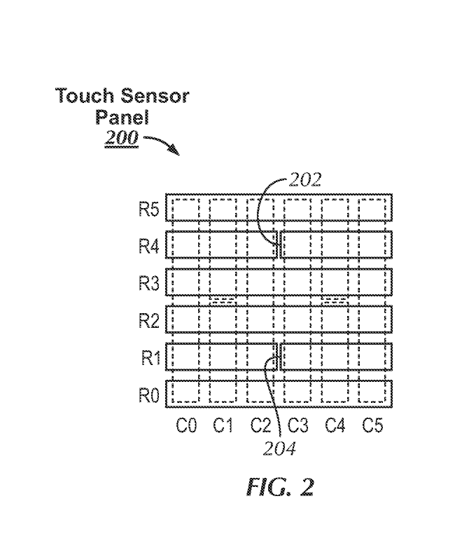

FIG. 2 illustrates exemplary touch sensor panel 200 according to some embodiments of the disclosure. In the example of FIG. 2, touch sensor panel 200 can be configured as a projection-scan self-capacitive (i.e., projected self capacitance) touch sensor panel. In this type of touch sensor panel, each of the sensing points can be provided by an individually charged electrode or pixel that can have a certain self-capacitance to ground. As an object approaches the surface of the touch sensor panel, the object can capacitively couple to those electrodes or pixels in close proximity to the object, creating an additional capacitance to ground and effectively increasing the self-capacitance of the electrode or pixel. The amount of charge in each of the electrodes or pixels can be measured by a capacitive scanning system to determine the positions of objects in close proximity to the touch sensor panel. It should be understood that although FIG. 2 illustrates an exemplary split row self capacitance touch sensor panel, other self and mutual capacitance configurations are also possible, including but not limited to various combinations of orthogonal, non-orthogonal (e.g., axial), single and double sided arrangements for use with various types of sensor arrays and individual sensors including, but not limited to, button sensors, plate sensors (no expected human contact), proximity sensors, and the like.

The exemplary touch sensor panel of FIG. 2 includes six elongated electrodes (i.e., rows R0-R5) oriented along a first dimension. Although the touch sensor panel is shown to include six rows of electrodes, it should be understood that embodiments of the disclosure are not so limited and can include a different number of rows. One skilled in the art can easily adopt the features disclosed in the illustrated embodiment to touch sensor panels of different sizes. In the example of FIG. 2, rows R1 and R4 each include break 202, 204 that splits each of rows R1 and R4 into two subsections. The rows that are physically split into two or more subsections by breaks may be referred to as “split rows” hereinafter. The two subsections of each split row can each have a self-capacitance detected in an area over their respective subsections. As a result, a touch over one subsection can be distinguished from a touch over the other subsection. Each of the electrodes in the rows can be coupled to a touch controller by one or more traces and/or wires.

When a touch occurs over both subsections of the same split row, a change in capacitance can be detected at both subsections. Because the touch is spread between the two subsections of the split row, the magnitude of the resulting change in capacitance detected by either subsection can be smaller than that of a touch detected solely by one subsection. In such an occurrence, a ratio of the capacitance changes can be calculated to reflect the breakdown of how a touch is spread over the two subsections. For example, a ratio of 20% to 80% can be interpreted as twenty percent of the touch being over one subsection and eighty percent of the touch being over the other subsection. This ratio can also be used to estimate the location of the touch over a non-split conductive region (e.g., non-split rows R0, R2, R3, and R6).

The same concept of using breaks to divide one or more row electrodes as shown in FIG. 2 and discussed above can also be incorporated into one or more of the columns of the projection-scan touch sensor panel as shown by the dashed lines in FIG. 2. However, it should be understood that in other embodiments, only the rows (or only the columns) can be present.

In various embodiments, different rows and columns of a projection-scan touch sensor panel can be split into subsections as discussed above. In addition, different numbers of the rows and/or columns can be split into two or more subsections. If a row or column is split to more than two subsections, the ratio can be calculated among all of the subsections and reflect the portions of a touch over each subsection. However, the number of breaks in a projection-scan touch sensor panel can be kept to a minimum while still allowing enough data to be collected to enable the processor to disambiguate multiple touches on the panel (i.e., to avoid rotational ambiguity caused by multiple touches detected simultaneously.) One advantage of keeping the number of breaks to a minimum is that, for every additional break in a row, an extra sensor channel may be needed on the touch controller, thus increasing the size of the chipset of the touch sensor panel. This can create a problem, especially in small touch sensor panels where extra space is hard to find. Therefore, to minimize the number of breaks needed for disambiguating multiple touches, the breaks can be incorporated into certain rows and columns to ensure that a touch can always overlap with a single row split and a single column split regardless of the location of the touch on the surface of the touch sensor panel.

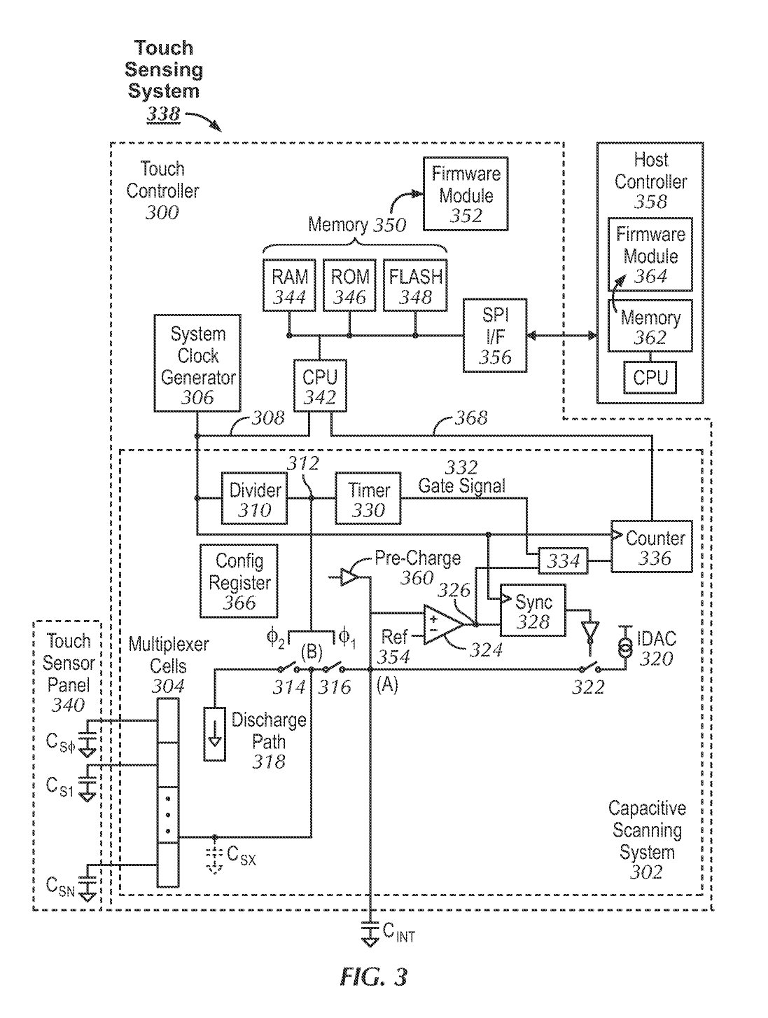

FIG. 3 provides a more detailed view of exemplary touch sensing system 338 including more detailed block diagrams of touch controller 300 and capacitive scanning system 302 according to some embodiments of the disclosure. Because FIG. 3 presents a mixture of functional blocks and circuit elements for purposes of illustration only, it should be understood that other blocks and elements can be substituted. In the example of FIG. 3, the capacitances of electrodes or pixels in touch sensor panel 340 are represented by capacitances C_{S0}-C_{SN}. In some embodiments, multiplexer cells 304 within touch controller 300 can couple the capacitance of one electrode or pixel in touch sensor panel 340 to capacitive scanning system 302, represented symbolically as C_{SX}. However, in other embodiments, the capacitance of two or more electrodes or pixels can be coupled to capacitive scanning system 302. This can be advantageous, for example, when performing a low-power scan for which only the existence, but not the location, of a touch or near-touch is to be determined. Configuration of multiplexer cells 304 can be performed using firmware module 352 stored in one or more of RAM 344, ROM 346 and flash 348 (collectively memory 350), which can be executed to store values into a hardware register 366 for configuring and re-configuring the multiplexer cells and other scan circuits during the scanning process.

System clock generator 306 can generate system clock 308 (e.g., 24 MHz), which can be divided down by a certain amount by divider 310 to produce divided down clock 312 (e.g., 1.5 MHz). Divided down clock 312 can also control timer 330, which can produce gate signal 332 that controls the time period (gate interval) during which the capacitance C_{SX} can be evaluated (e.g., 200 us). Opposite phases (φ1 and φ2) of divided down clock 312 produced by divider 310 can be used to control switches 314 and 316. When switch 314 is open and switches 316 and 322 are closed, capacitance C_{SX} together with integration capacitance C_{INT} can be charged by sourcing output digital to analog converter (IDAC) 320. When switch 314 is closed, switch 316 is open and switch 322 is closed, capacitance C_{SX} can discharge through discharge path 318, and integration capacitance C_{INT} can be charged by IDAC 320. When switch 314 is closed and switches 316 and 322 are open, capacitance C_{SX} can continue to discharge through discharge path 318, but the integration capacitance C_{INT} is no longer charged by IDAC 320. When switches 314 and 322 are open and switch 316 is closed, capacitance C_{INT} can discharge into C_{SX} (assuming C_{SX} is substantially discharged). The various charging and discharging states summarized above are described in more detail below. The voltage at C_{INT}, point (A), can be coupled to the positive input of comparator 324, whose negative input can be held at configurable reference voltage 354.

A single charge/discharge cycle will now be described. Initially, after C_{INT} has discharged into C_{SX}, both C_{INT} and C_{SX} can begin to charge up through current supplied by IDAC 320. At some point during charging, divider 310 can cause switch 316 to open and switch 314 to close, which can cause C_{SX} to discharge through discharge path 318, while C_{INT} continues to charge through IDAC 320. As C_{INT} charges, if the voltage at point (A) exceeds reference voltage 354 (e.g., 1.2V) established at the negative input of comparator 324, output 326 of comparator 324 can transition to a high state. This high state on output 326 can be synchronized to system clock 308 by synchronization circuit 328. In some embodiments, synchronization circuit 328 can be a double sync circuit to delay the opening of switch 322 by several system clock periods to ensure that the voltage at point (A) exceeds reference voltage 354 by a sufficient margin as to prevent noise from toggling comparator 324. Output 326 can also be gated with gate signal 332 (using generic logic gate 334) and provided to counter 336. In some embodiments, counter 336 can begin to increment its count at the system clock rate once the voltage at C_{SX} and C_{INT} exceeds reference voltage 354 (i.e., after output 326 becomes asserted) and gate signal 332 is asserted (i.e., at a logic one or high voltage). Counter 336 can thereafter count up at the system clock rate as long the voltage at C_{INT} remains above reference voltage 354. A high state on synchronization circuit 328 can also open switch 322, which can prevent IDAC 320 from charging C_{INT} any further. When divider 310 causes switch 314 to open and switch 316 to close (with switch 322 still open), C_{INT} can discharge into C_{SX}, and the voltage at point (A) can drop below reference voltage 354, causing comparator output 326 to go low and switch 322 to close, which can begin another charging cycle. In general, therefore, embodiments of the disclosure attempt to maintain a threshold voltage at C_{INT} by sourcing current through IDAC 320 and subtracting current through C_{SX}. The aforementioned circuitry is collectively be referred to herein as charge/discharge circuitry.

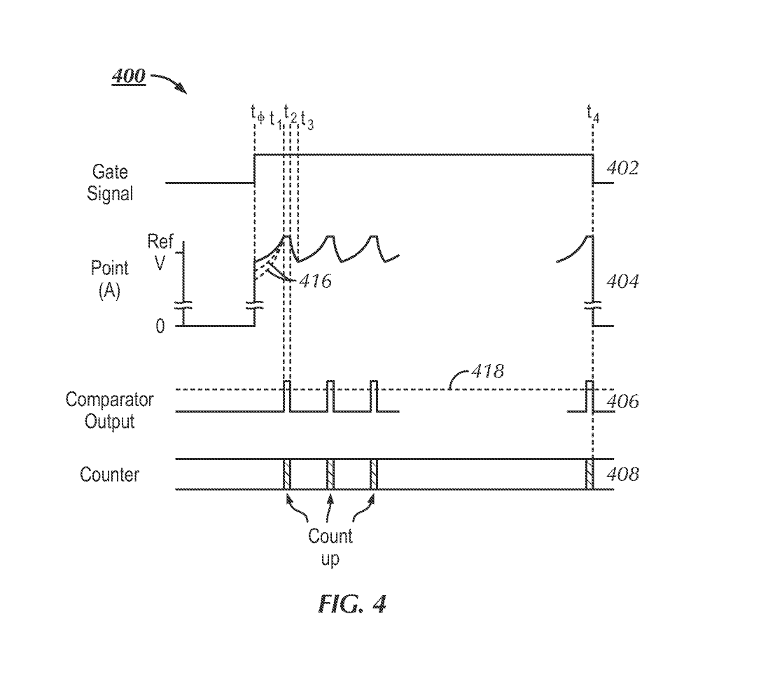

FIG. 4 illustrates exemplary timing diagram 400 of certain operations of FIG. 3 according to some embodiments of the disclosure. In the example of FIG. 4, at time t0, C_{SX} and C_{INT} can be pre-charged towards some pre-charge voltage 414 prior to the start of a capacitance measuring phase, although in some embodiments C_{SX} and C_{INT} may not actually reach the desired pre-charge voltage 414. At time t0 the gate signal can be asserted (see waveform 402), signifying the start of a capacitance measurement phase. The time during which the gate signal is asserted (e.g., t4-t0 in FIG. 4) may also be referred to herein as the gate interval. In one embodiment, the gate interval can be about 200 microseconds. Between time t0 and t1, C_{INT} (and for some of the time, C_{SX}) can charge up through the sourcing IDAC, and the voltage at point (A) (see waveform 404) can begin to rise. As long as the voltage at point (A) remains below the reference voltage, the comparator output (see waveform 406) will not be asserted and the counter (see waveform 408) will not be incremented. At time t1, the voltage at point (A) can exceed the reference voltage, which can cause the comparator output to transition to a high state (see waveform 406) and prevent the IDAC from charging C_{INT} any further. From time t1 to time t2, C_{INT} is no longer being charged, and the counter can increment its count at the system clock rate (see waveform 408). At time t2, C_{INT} can discharge into C_{SX}. As a result, the voltage at point (A) can drop below the reference voltage, which can cause the comparator output to transition to a low state and reconnect the IDAC to C_{SX} and C_{INT}. At time t3, C_{SX} and C_{INT} can once again begin to charge.

The charging, counting, and discharging operations can be repeated until time t4, when the capacitance measurement phase can end. At time t4, the number of counts N accumulated by the counter can provide an indication of the duty cycle of the comparator (see inverse duty cycle 418 in FIG. 4), and also an indication of the capacitance C_{SX} being measured. Smaller values for C_{SX} can result in faster charge times (e.g., t1-t0), which can further result in a greater duration of time during the gate interval at which the voltage at point (A) exceeds the reference voltage, ultimately resulting in a higher comparator inverse duty cycle 418 and a higher count per gate interval. Conversely, larger values for C_{SX} can result in slower charge times (e.g., t1-t0), which can further result in fewer instances in which the voltage at point (A) exceeds the reference voltage, ultimately resulting in a lower comparator inverse duty cycle 418 and a lower count per gate interval. Because an object in close proximity with a self-capacitive sensor can increase the self-capacitance of the sensor, a lower count N can be indicative of a touch or near touch over the touch sensor panel. The count N, representative of the capacitance being measured, can be read by CPU 342 via path 368 and passed to host controller 358 through interface 356, for example. It should be understood that path 368, although symbolically illustrated by a line, can represent any communicative coupling known to those skilled in the art.

Referring again to FIG. 3, system clock 308 can be coupled to CPU 342. CPU 342, along with RAM 344, ROM 346 and flash 348, can configure and control capacitive scanning system 302 under control of system clock 308 to obtain and forward touch data to host controller 358. In some embodiments, firmware module 352 can be stored in one or more of RAM 344, ROM 346 and flash 348 (collectively memory 350), and then executed at run time to store values into hardware register 366 for configuring various parameters of capacitive sensing system 302. Configurable blocks and elements in touch controller 300 can include, but are not limited to, system clock generator 306, divider 310, timer 330, pre-charge buffer 360, reference voltage 354, and IDAC 320. For example, hardware register 366 can configure a trim register in system clock generator 306 for changing the system clock frequency, can configure IDAC 320 to generate a particular source current to maintain a certain comparator duty cycle during no-touch conditions, and can configure timer 330 to generate different gate intervals and gate signals 332.

In addition, a serial peripheral interface (SPI) 356 can be employed to allow host controller 358 to access reports containing information about the performance of touch controller 300. Software module 364 executable by host controller 358 can read and interpret these reports, determine any necessary adjustments, and send communications (e.g., configuration information) back to touch controller 300 to make changes to the parameters of touch controller 300 during run-time. Such changes can include, but are not limited to, modifying hardware registers, RAM and flash. These changes can be made during factory calibration, repair, or maintenance, often at the direction of personnel running evaluation/calibration programs, and can also be made automatically in the field while the device is in use at the direction of firmware in host controller 358.

In some embodiments, divided down clock 312 (that controls switches 314 and 316) may not be synchronized with the start of the gate signal 332 from timer 330. In other words, the charge/discharge cycle driven by divided down clock 312 may not be synchronized with the capacitance measurement cycle started (enabled) by asserted gate signal 332. In such embodiments, quantization or measurement noise can occur due to the indeterminate nature of the timing relationship between the two cycles. In this context, quantization noise can manifest itself as variability in the number of counts recorded by counter 336. For example, it should be understood that in some embodiments, divider 310 can repeatedly open and close switches 314 and 316, which can result in repeated charge and discharge phases and repeated time periods during which comparator output 326 is asserted. Nevertheless, as long as gate signal 332 from timer 330 is not asserted, counter 336 will not count up. Therefore, in some instances, the start of the capacitance measurement phase can be entered (i.e., gate signal 332 becomes asserted) while comparator output 326 is low (i.e., during a charge portion of the charge/discharge cycle), and counter 336 will not immediately begin to count up. However, if the start of the capacitance measurement phase is entered while comparator output 326 is high, counter 336 will immediately begin to count up. The number of counts can depend on the time at which gate signal 332 goes high relative to the remaining duration of the asserted comparator output. The scan-to-scan variability in these initial counts (count errors) can result in a mischaracterized capacitance value.

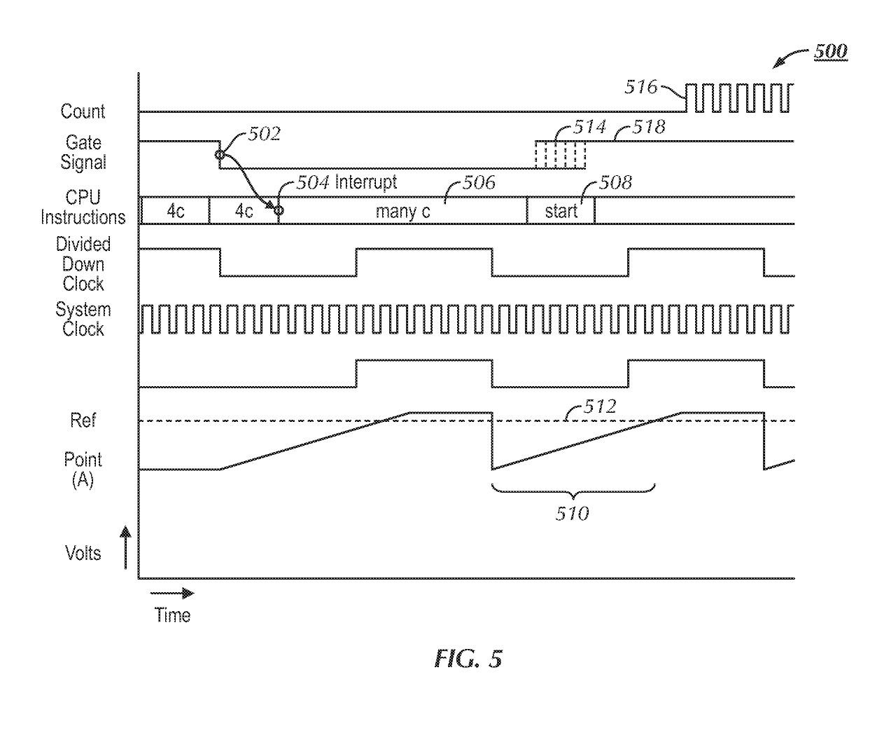

FIG. 5 illustrates timing diagram 500 showing an exemplary synchronization of the start of the capacitance measurement cycle and the charge/discharge cycle according to some embodiments of the disclosure. In the example of FIG. 5, a deasserting (e.g., falling) edge of gate signal at 502 can be used to cause the CPU, under control of firmware, to generate interrupt 504 at the next CPU instruction boundary (in the example embodiment of FIG. 5, an instruction is at least four system clock periods in length). Interrupt 504 can cause the touch controller CPU to wait a specific number of system clock periods 506 (i.e., generate a delay) before generating start instruction 508, which then causes the gate signal to be asserted at 514 (dashed lines indicate some variability in the actual rising edge). The specified wait time 506 can be designed to cause start instruction 508 and asserted gate signal 514 (i.e., the start of the capacitance measurement cycle) to occur when C_{INT} is charging and is below reference voltage 512 (see window 510). In this window of time, the comparator output will not be asserted and the counter will not be counting up. In fact, the counter will not start counting up until C_{INT} has charged up above reference voltage 512 and the comparator output is asserted (see start of count at 516). In this manner, there should be no variability in initial counts when the gate signal is first asserted during a scan or gate interval—the timing of the start instruction should prevent any initial counts from occurring when the gate signal is first asserted. In some embodiments, this synchronized asserted gate signal can be generated under control of a processor executing firmware, and logic and circuits within the touch controller.

In some embodiments, falling edge 502 of gate signal can be the result of an extra pulse generated from the timer. In such embodiments, firmware can configure the timer to produce a short pulse in advance of regular gate signal 518. The falling edge of this pulse at 502 can trigger interrupt 504 as described above. However, in other embodiments, falling edge 502 can simply be the falling edge of the previous regular gate signal 518, and additional instructions may be needed to ensure that start instruction 508 occurs at the desired time. In either embodiment, firmware can be employed to synchronize the start of the capacitance measurement phase and the gate signal.

Referring now to both FIGS. 3 and 4, scan noise can occur when, at the beginning of a capacitance measurement cycle or scan, capacitances C_{SX} and C_{INT} begin charging before the voltage at those capacitances (point A in FIG. 3) has reached a predetermined fixed voltage level. For example, during different scans, point A can begin charging from different values (see dashed lines 416 in FIG. 4), which can result in some variability in counts and inconsistent measurements (scan noise). In some embodiments, this inconsistent start voltage can be caused, in part, by the delays inherent in turning on IDAC 320 and the reference voltage settling time. Therefore, according to some embodiments of the disclosure, IDAC 320 combined with a reference voltage generated by pre-charge buffer 360 controlled by firmware module 352, after settling over a period of time, can produce a start voltage that can ensure that point A is fully charged up to a fixed voltage 414 prior to the start of a scan. In such embodiments, the IDAC can be manually enabled under firmware control prior to starting the scan to connect to point A (bypassing switch 322). Additionally, pre-charge buffer 360, which is connected to the reference voltage, can be enabled to drive the reference voltage onto point A. After settling, the scan hardware and logic can be enabled, which can then automatically enable the IDAC as controlled by the comparator output. At this point in time, the IDAC should be fully turned on and operational. This is in contrast to conventional systems in which the capacitive measurement cycle is entered without having the IDAC fully operational, which can lead to measurement errors. In this manner, all scans can commence with point A being at the same voltage and the IDAC fully operational, resulting in more consistent measurements and less scan noise.

As described above, C_{SX} can be repeatedly charged and discharged under the control of divided down clock 312. Therefore, at point (B) in FIG. 3 for example, the voltage waveform can be repeated transitions between 0V and 1.2V. The sharp edges and rapid transitions at point (B) can contain a large amount of energy which can be radiated as noise. If these charge/discharge cycles occur at a certain frequency, interference with other devices and broadcasts such as FM radio can occur.

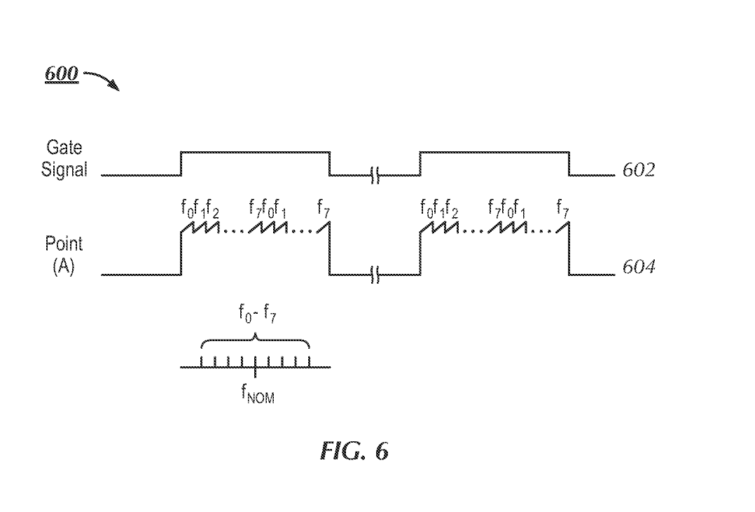

FIG. 6 illustrates timing diagram 600 of several exemplary capacitive measurement phases according to some embodiments of the disclosure. In the example of FIG. 6, multiple gate intervals 602 are shown, each interval having multiple charge/discharge periods symbolically illustrated by a sawtooth pattern. Each charge/discharge period can be performed at slightly different frequencies to avoid generating significant noise at a particular frequency. Referring again to FIG. 3, system clock generator 306 can be controlled by firmware module 352 to change the system clock frequency and consequently the frequency of successive charge/discharge periods. In one embodiment, a trim register in system clock generator 306 can be used to change its operating frequency. In particular, firmware module 352 can modify the trim register in an uninterrupted loop during the capacitive measurement cycle. The frequency can change at a rate that is synchronous to the system clock, but not necessarily synchronous to the divided down clock edge. For example, if system clock 308 was 24 MHz and divided down clock 312 was 1.5 MHz, successive charge/discharge periods can be performed using eight repeating frequencies (see f0-f7 in waveform 604) centered around a nominal scan frequency (f_{NOM}) of 1.5 MHz and spread over a 64 kHz band so that each frequency varies from the next by 8 kHz. Although FIG. 6 illustrates a regular sequence of repeating frequencies f0-f7, other frequencies and distributions are possible. For example, the order of frequencies, the number of different frequencies or the spacing of the frequencies may vary under firmware control, as long as they are maintained in a consistent manner throughout the scanning of the entire touch sensor panel.

The accuracy of the touch sensing system can be affected by external noise (noise aggressors). Therefore, according to some embodiments of the disclosure, the nominal scan frequency (f_{NOM}) can be adjusted to avoid noise aggressors. In some embodiments, firmware can be used to adjust the nominal scan frequency. In one embodiment, the firmware can modify a trim register in system clock generator 306 to change its operating frequency. In some embodiments, suspect touch image data (e.g., data indicative of continuous touch events or no touch events over long periods of time) can be detected by the firmware, and under the assumption that the data may be corrupted by a noise aggressor, the firmware can then change the nominal scan frequency. In some embodiments, this process can be repeated as necessary, and the firmware can change the nominal scan frequency to different frequencies until the touch image data no longer appears suspect. Different criteria can be established to enable the firmware to determine when the touch data appears suspect. For example, touch data that changes more rapidly than some predetermined threshold, or no-touch data having a steady state value that is outside of some predetermined range, may all be indicative of suspect touch data.

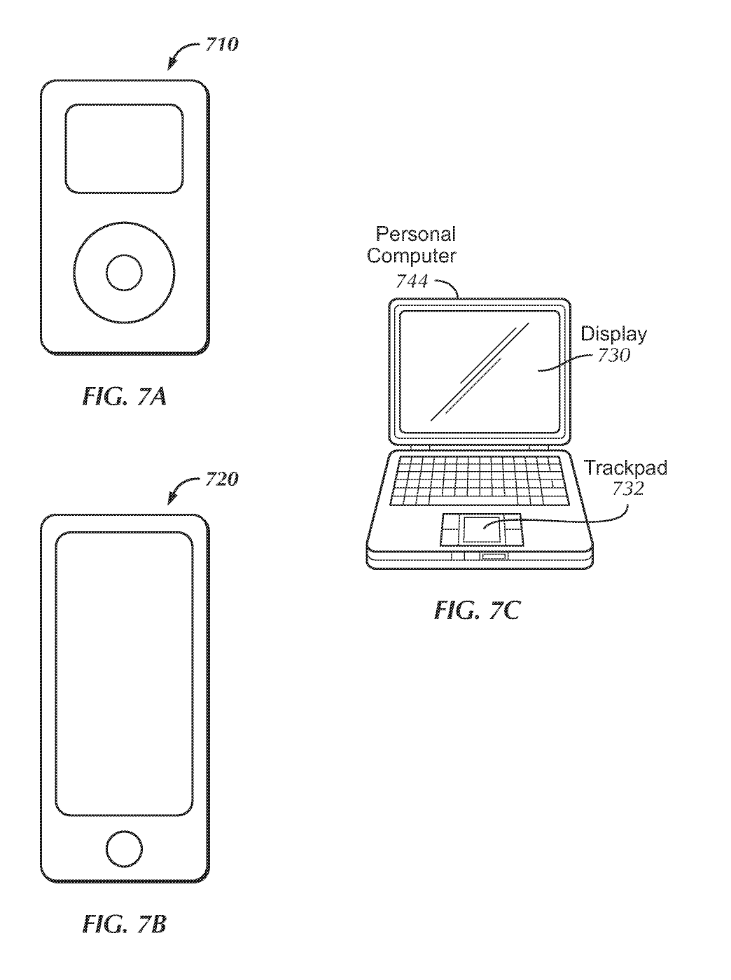

FIG. 7a illustrates exemplary digital media player 710 that can include a touch sensing system according to some embodiments of the disclosure.

FIG. 7b illustrates exemplary mobile telephone 720 that can include a touch sensing system according to some embodiments of the disclosure.

FIG. 7c illustrates an exemplary personal computer 744 that can include trackpad 732 and display device 730. Trackpad 732, and optionally display 730, can have touch sensing capability and can be part of a touch sensing system according to some embodiments of the disclosure.

Referring again to FIG. 1, capacitive sensing system 120 can perform actions that can include, but are not limited to, moving an object such as a cursor or pointer, scrolling or panning through lists, photos or other media items, adjusting control settings, opening a file or document, viewing a menu, making a selection, executing instructions, operating a peripheral device coupled to the host device, answering a telephone call, placing a telephone call, terminating a telephone call, operating an FM radio, changing the volume or audio settings, storing information related to telephone communications such as addresses, frequently dialed numbers, received calls, missed calls, logging onto a computer or a computer network, permitting authorized individuals access to restricted areas of the computer or computer network, loading a user profile associated with a user's preferred arrangement of the computer desktop, permitting access to web content, launching a particular program, encrypting or decoding a message, and/or the like. Host controller 104 can also perform additional functions that may not be related to touch sensing, and can be coupled to program storage and display 118 such as an LCD panel for providing a UI to a user of the device.

Note that one or more of the functions described above can be performed by firmware stored in memory (e.g., memory 350 or memory 362 in FIG. 3) and executed by touch controller 300 or host controller 358. The firmware can also be stored and/or transported within any computer-readable storage medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable storage medium” can be any medium that can contain or store the program for use by or in connection with the instruction execution system, apparatus, or device. The computer readable storage medium can include, but is not limited to, an electronic, magnetic, optical, electromagnetic, infrared, or semiconductor system, apparatus or device, a portable computer diskette (magnetic), a random access memory (RAM) (magnetic), a read-only memory (ROM) (magnetic), an erasable programmable read-only memory (EPROM) (magnetic), a portable optical disc such a CD, CD-R, CD-RW, DVD, DVD-R, or DVD-RW, or flash memory such as compact flash cards, secured digital cards, USB memory devices, memory sticks, and the like.

The firmware can also be propagated within any transport medium for use by or in connection with an instruction execution system, apparatus, or device, such as a computer-based system, processor-containing system, or other system that can fetch the instructions from the instruction execution system, apparatus, or device and execute the instructions. In the context of this document, a “transport medium” can be any medium that can communicate, propagate or transport the program for use by or in connection with the instruction execution system, apparatus, or device. The transport readable medium can include, but is not limited to, an electronic, magnetic, optical, electromagnetic or infrared wired or wireless propagation medium.

Although embodiments of this disclosure have been fully described with reference to the accompanying drawings, it is to be noted that various changes and modifications will become apparent to those skilled in the art. Such changes and modifications are to be understood as being included within the scope of embodiments of this disclosure as defined by the appended claims.

What is claimed is:

1. An apparatus for synchronizing a capacitive touch sensing system to avoid capacitance measurement errors, comprising:
a counter configured for generating a count value indicative of a capacitance during a capacitance measurement cycle; and
a processor programmed for
triggering an interrupt from an end of a previous capacitance measurement cycle, and
starting a new capacitance measurement cycle a predetermined delay after the interrupt is received;
wherein the delay is selected such that the start of the new capacitance measurement cycle occurs within a charge portion of a capacitance charge/discharge cycle and the counter is disabled.

2. The apparatus of claim 1, the processor further programmed for:
triggering the interrupt from a deasserting edge of a gate signal signifying the end of the previous capacitance measurement cycle; and
generating an asserting edge of the gate signal to start the new capacitance measurement cycle.

3. The apparatus of claim 2, the processor further programmed for:
generating a start instruction after waiting the predetermined delay after the interrupt is received; and
generating the asserting edge of the gate signal from the start instruction to start the new capacitance measurement cycle.

4. The apparatus of claim 2, the processor further programmed for generating an extra pulse on the gate signal prior to generating the asserting edge of the gate signal, the extra pulse including the deasserting edge of the gate signal.

5. The apparatus of claim 4, further comprising:
a timer circuit configured for generating the gate signal;
wherein the processor further is programmed for generating the extra pulse through firmware configuration of the timer circuit.

6. A method of synchronizing a capacitive touch sensing system to avoid capacitive measurement errors, comprising:
providing a firmware delay from an end of a previous capacitive measurement cycle to a start of a new capacitive measurement cycle;
wherein the firmware delay is selected to cause the new capacitance measurement cycle to begin during a charge portion of a capacitance charge/discharge cycle when a counter indicative of a capacitance value is disabled.

7. The method of claim 6, further comprising:
providing the firmware delay from a deasserting edge of a gate signal signifying the end of the previous capacitive measurement cycle;
generating a subsequent asserting edge of the gate signal after the firmware delay; and
starting the new capacitance measurement cycle after receipt of the subsequent asserting edge of the gate signal.

8. The method of claim 7, further comprising generating an extra pulse on the gate signal prior to the subsequent asserting edge of the gate signal, the extra pulse including the deasserting edge of the gate signal.

9. The method of claim 8, further comprising generating the extra pulse through firmware configuration of a timer circuit that generates the gate signal.

10. A computer-readable storage medium comprising program code for synchronizing a start of a capacitance measurement cycle and a charge/discharge cycle in a touch sensing system to avoid count errors, the program code for causing performance of a method comprising:
triggering an interrupt from a deasserting edge of a gate signal;
generating a start instruction a certain delay after the interrupt is received; and
generating an asserting edge of the gate signal from the start instruction to start the capacitance measurement cycle;
wherein the delay is selected such that the asserting edge of the gate signal occurs within a charge portion of the charge/discharge cycle and when a counter indicative of a capacitance value is disabled.

11. The computer-readable storage medium of claim 10, the program code further for causing performance of a method comprising generating an extra pulse on the gate signal prior to the asserting edge of the gate signal, the extra pulse including the deasserting edge of the gate signal.

12. The computer-readable storage medium of claim 11, the program code further for causing performance of a method comprising generating the extra pulse through firmware configuration of a timer circuit that generates the gate signal.

13. The computer-readable storage medium of claim 10, wherein the deasserting edge of the gate signal is a previous gate signal associated with a preceding capacitance measurement cycle.

14. An apparatus for synchronizing a capacitive touch sensing system to avoid capacitance measurement errors, comprising:
a charge/discharge circuit configured for performing multiple charge/discharge cycles within a capacitance measurement cycle to obtain a duty cycle indicative of a capacitance of an electrode in the touch sensing system; and
a processor programmed for
triggering an interrupt from an end of a previous capacitance measurement cycle, and
starting a new capacitance measurement cycle a predetermined delay after the interrupt is received;
wherein the delay is selected such that the start of the new capacitance measurement cycle occurs within a charge portion of a present capacitance charge/discharge cycle.

15. The apparatus of claim 14, the processor further programmed for:
triggering the interrupt from a deasserting edge of a gate signal signifying the end of the previous capacitance measurement cycle; and
generating an asserting edge of the gate signal to start the new capacitance measurement cycle.

16. The apparatus of claim 15, the processor further programmed for:
generating a start instruction after waiting the predetermined delay after the interrupt is received; and
generating the asserting edge of the gate signal from the start instruction to start the new capacitance measurement cycle.

17. The apparatus of claim 15, the processor further programmed for generating an extra pulse on the gate signal prior to generating the asserting edge of the gate signal, the extra pulse including the deasserting edge of the gate signal.

18. The apparatus of claim 17, further comprising:
a timer circuit configured for generating the gate signal;
wherein the processor further is programmed for generating the extra pulse through firmware configuration of the timer circuit.

19. A touch-sensitive electronic device including an apparatus for synchronizing a capacitive touch sensing system to avoid capacitance measurement errors, the apparatus comprising:
a counter configured for generating a count value indicative of a capacitance during a capacitance measurement cycle; and
a processor programmed for
triggering an interrupt from an end of a previous capacitance measurement cycle, and
starting a new capacitance measurement cycle a predetermined delay after the interrupt is received;
wherein the delay is selected such that the start of the new capacitance measurement cycle occurs within a charge portion of a capacitance charge/discharge cycle and the counter is disabled.

20. The touch-sensitive electronic device of claim 19, the processor further programmed for:
triggering the interrupt from a deasserting edge of a gate signal signifying the end of the previous capacitance measurement cycle; and
generating an asserting edge of the gate signal to start the new capacitance measurement cycle.

21. The apparatus of claim 20, the processor further programmed for:
generating a start instruction after waiting the predetermined delay after the interrupt is received; and
generating the asserting edge of the gate signal from the start instruction to start the new capacitance measurement cycle.

22. A method of minimizing noise generated in a capacitance measurement cycle of a touch sensing system, comprising:
performing multiple charge/discharge cycles to obtain a duty cycle indicative of a capacitance of an electrode in the touch sensing system;
wherein each of the multiple cycles are performed at one of a plurality of different frequencies surrounding a nominal charge/discharge frequency.

23. The method of claim 22, further comprising utilizing firmware to control an output of a system clock generator to produce the plurality of different frequencies.

24. An apparatus for minimizing noise generated in a capacitance measurement cycle of a touch sensing system, comprising:
a charge/discharge circuit; and
a processor programmed for controlling the charge/discharge circuit to perform multiple charge/discharge cycles to obtain a duty cycle indicative of a capacitance of an electrode in the touch sensing system;
wherein each of the multiple cycles are performed at one of a plurality of different frequencies surrounding a nominal charge/discharge frequency.

25. The apparatus of claim 24, further comprising a system clock generator, the processor further programmed for controlling an output of the system clock generator to produce the plurality of different frequencies.
